(19) United States
(12) Patent Application Publication
(10) Pub. No.: US 2007/0263211 A1
(43) Pub. Date: Nov. 15, 2007

(54) Portable VUV spectrometer

(76) Inventors: Dennis M. Manos, Williamsburg, VA (US); Sheng Peng, Williamsburg, VA (US)

Correspondence Address: WILLIAM G. AUTON;ESC/JAZ, 40 WRIGHT STREET, HANSCOM AFB, MA, 01731-2903, US

(21) Appl. No.: 11/434,574

(22) Filed: May 10, 2006

(51) Int. Cl. G01J 3/28

(52) U.S. Cl. 356/326

(57) ABSTRACT

In accordance with this invention, a housing and adaptors to receive a commercial off-the-shelf compact spectrometer was built. The resulting system is particularly adapted for VUV spectrum measurements. Currently portable spectrometer systems have wavelength cutoff at 200 nm or 300 nm, but by adding out invention, we successfully extend this limit to 150 nm. This unit has proven to provide good performance in wavelength region below 200 nm, working under vacuum or purging. In this invention we also performed wavelength and intensity calibration, which makes this instrument ready for immediate industrial manufacture.

### STATEMENT OF GOVERNMENT INTEREST

The invention described herein may be manufactured and used by or for the Government for governmental purposes without the payment of any royalty thereon.

### BACKGROUND OF THE INVENTOR

Spectrometers are very sensitive instruments mainly used for light detection. Typical applications are in the field of process control and quality assurance in the lamp industry, fluorescence applications in several areas, color measurement applications as well as applications in the field of R&D, for example in biomedicine. In all these fields, a portable spectrometer system is preferable if its performance reaches or is beyond the application requirements.

Many efforts have been devoted to portable spectrometer systems because of their applications mentioned on above. Commercial system providers include OceanOptics, Analytical Spectral Devices Inc., StellarNet Inc., and etc. However these systems have a wavelength cutoff at 200 um.

UV emissions in the range 180 nm-200 nm are very important because of the responsiveness of many materials in this wavelength range. UV sources can selectively drive radical-mediated processes such as UV curing, protective and function coating, pollution control, photo-depositions, thus measurements in this region with a portable spectrometer are very useful.

The object of present invention is to extend the wavelength region of current portable spectrometers to VUV.

### SUMMARY OF THE INVENTION

In this invention, we built a very compact, portable VUV spectrometer based on an OceanOptics S1024DW spectrometer. The S1024DW Deep Well Detector Spectrometer from OceanOptics features a 1024-element photodiode array (PDA) for applications requiring high signal-to-noise (S/N) measurements. With a 2400 line grating blazed at 150 nm and a 100 micron slit, this spectrometer provides a solution of 1.12 nm at around 190 nm. Our invention extends the wavelength measurement range down to 150 nm, and makes it a very useful portable spectrometer in VUV.

The size of this unit is 22×1510 c m. Its total weight is 10.5 kg, excluding the weight of pumps if it is used under vacuum. The system includes an OceanOptics 1024DW spectrometer, and A/D converter (SAD500), a stainless vacuum chamber, a free-beam light delivery system, a power adapter, and data cables.

The grating was rotated for an effective wavelength range from 150 nm to 300 nm. Since UV emission below 200 nm is strongly absorbed by air and some other surface materials, special modifications must be taken for high performance in VUV. First of all, the window on top of the PDA was removed to increase VUV response of the PDA. We built a stainless vacuum chamber to eliminate air absorption. A free-beam light delivery system was designed attaching to the chamber. Since most regular circuits components inside the A/D unit (SAD500) have the out gassing problem (materials leak out under vacuum), which may deposit a thin layer on optical bench, this unit was taken out of the vacuum cavity.

### DESCRIPTION OF THE DRAWINGS

The accompanying drawings illustrate a complete embodiment of the invention according to the best modes so far devised for the practical applications, and in which:

FIG. 1 is a photograph of the system on site. The white unit on top of the cavity is the A/D converter.

FIG. 2 is the free-beam light delivery system which overcomes air absorption.

FIG. 3 is the detailed engineering drawing for the vacuum chamber.

FIG. 4 is a spectrum of an Hg—Ar calibration lamp taken in the compact system.

FIG. 5 is a spectrum, of the Xe second continuum (600 torr, 140 W input rf power taken from our RF lamp) obtained by the compact system showing a good UV response down to 150 nm.

FIG. 6 shows a spectrum of Xe second continuum (600 torr. 140 W input rf power) taken in a normal-size VUV spectrometer (McPherson 218).

FIG. 7 is the characteristic curve for the absorption coefficient of the VUV compact spectrometer between 155-185 nm.

### DETAILED DESCRIPTION OF THE PREFERRED EMBODIMENTS

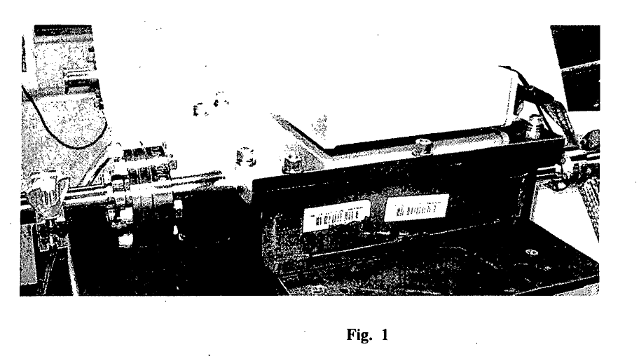

Referring now to the drawings, FIG. 1 is a photograph of the spectrometer system. The white unit on top of the cavity is the A/D converter (SAD500) that communicates between the spectrometer and a computer. It is connected to the built in data port of the vacuum cavity, and functions not only as an A/D converter but also as a controller of the spectrometer. In the vacuum side, the spectrometer is connected to the data port of the cavity by a ribbon cable with Kapton insulation for HV compatibility.

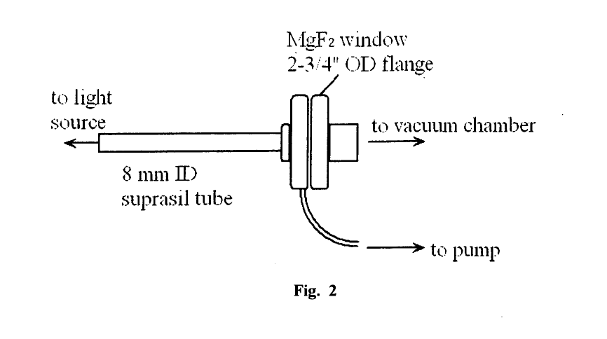

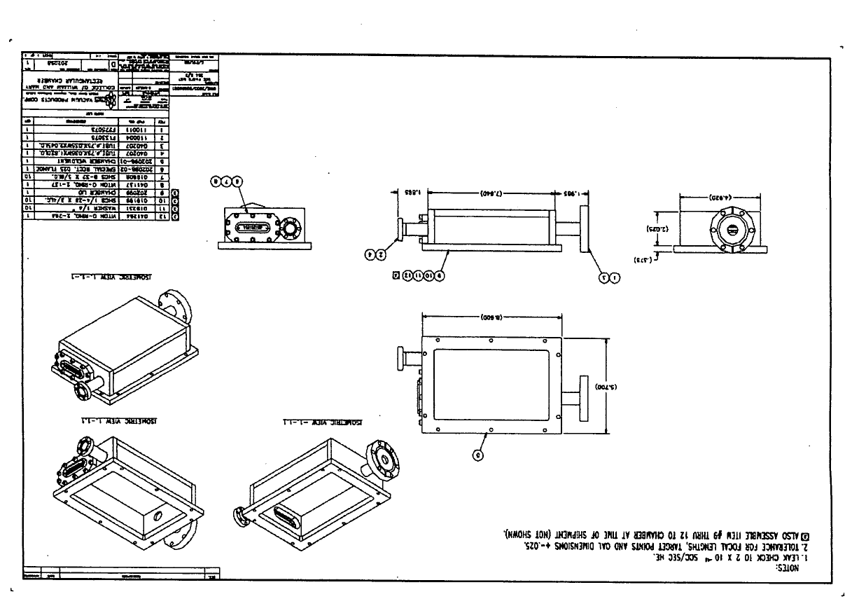

Because most fiber optic cables do not transmit below 190 nm, there must be a free-beam light delivery system (FIG. 2). This includes a flanged MgF₂ window right in front of the slit and an 8 mm ID suprasil tube evacuated to 1×10⁻⁵ torr and connected to a light source. FIG. 3 shows the details of the vacuum cavity. It consists of a 2¾″ OD flange, attached with a flanged MgF₂ window, a 1⅓″ OD flange connecting to pumps and a modified Hermetic Type-D subminiature feed through with gold plated pins as the data port. The cavity is sealed by a viton o-ring on the perimeter with bolts for mounting the lid. This cavity provides a vacuum condition with ultimate pressure below 1×10⁻⁶ torr. To save cost, weight and space, the cavity data port is made by modifying a round flange-mounted 25-pin connector to the desired size, which is then mounted directly to the face of the cavity with bolts. The walls of the cavity are made by ⅜″ thick stainless steel plates because of industry standard. If weight is a concern, the thickness could be reduced as long as it can withstand the pressure difference. We believe using plates with half of the thickness wouldn't lead to any problem. This could bring the total weight down to about 6 kg.

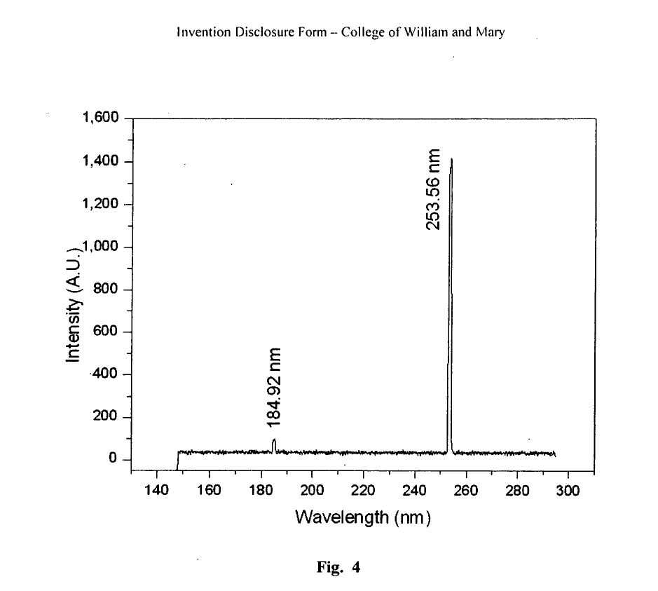

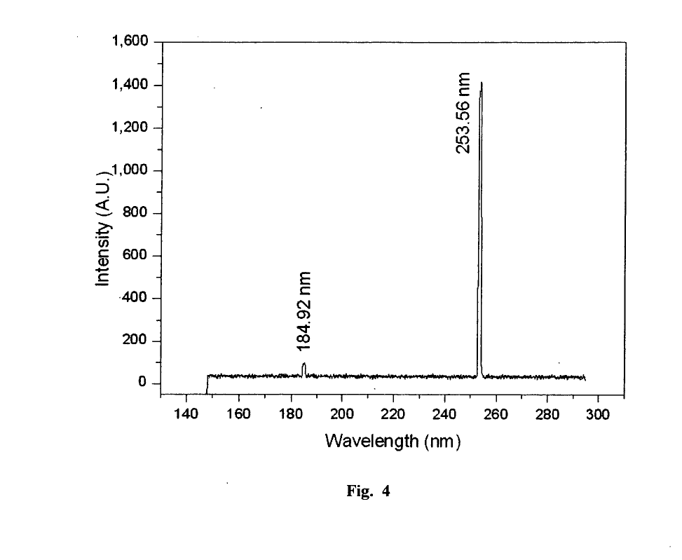

The system has been wavelength calibrated by an Hg—Ar wavelength calibration lamp from Oriel Instruments. FIG. 4 is a spectrum of an Hg—Ar calibration lamp taken in the compact system. The ratio of the two Hg I line intensities at 253.65 nm and 184.95 nm is 20:1, which is close to NIST traceable calibration data (15:1). This indicates that the possible absorption does not affect that line ratio very much at wavelengths where transitions were observed. The vacuum level of this system can be easily improved by improving the conductance of the external connections, and this problem can be easily overcome for applications that require working below 185 nm.

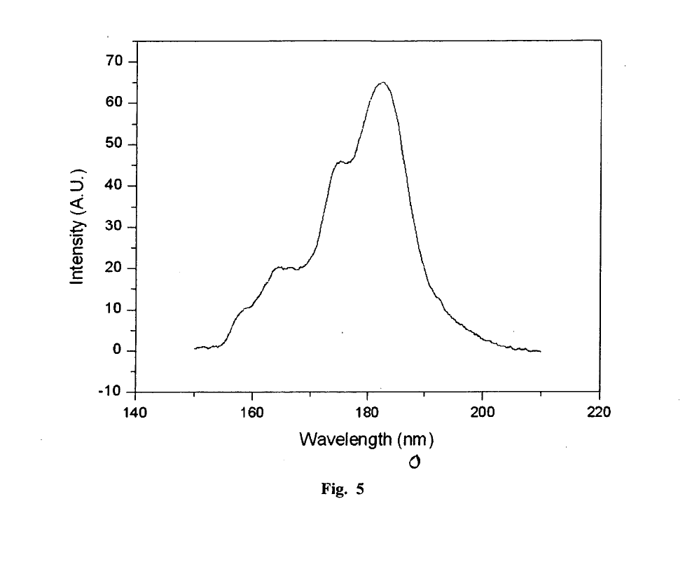

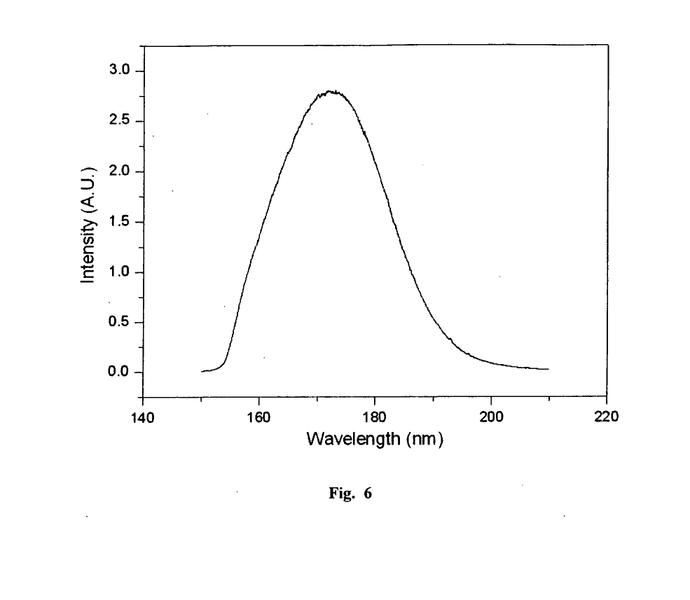

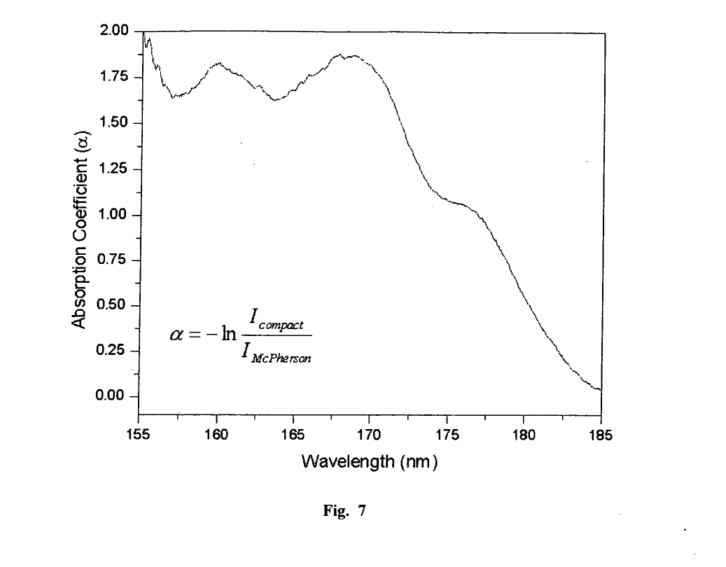

FIG. 5 is a spectrum of the Xe second continuum obtained from the compact system. Although this spectrum shows that this portable system is responsive all the way down to 155 nm, we see some evidence of absorption, possibly from air, the optical interface, or both. Since we are using a 4-foot long elbow (⅝ inch in diameter) to connect the vacuum chamber to pumps, the pressure (1×10⁻⁵ torr) measured at the far end, results in a base pressure estimated to be 1.1×10⁻⁴ torr inside the vacuum. chamber. This spectrometer was modified from a commercial version which has a wavelength cutoff at 200 nm. Although the window on top of the PDA was removed to improve UV sensitivity, the PDA itself is not calibration below 200 nm. Taking the point wise log of the ratio of this spectrum in FIG. 5 to that obtained in a much larger system (McPherson 218) operating below 1×10⁻⁶ torr (shown in FIG. 6), fitting the long wavelength shoulder where no absorption is assumed, yields the absorption coefficient curve shown in FIG. 7. This curve is the characteristic curve of the unit's response in VUV, which can be used to calibrate the output intensity down to 155 nm.

What are claimed include:

1. A portable VUV spectrometer comprising: a compact light deflecting system, and A/D converter, a stainless vacuum chamber, a free-beam light delivery system, a power adapter, and data cables.

2. A free-beam light delivery system comprising a flanged MgF₂ window right in front of the slit and a suprasil tube evacuated and connected to a light source.

3. A rectangular vacuum chamber comprising at least a flanged port for attaching of MgF₂ window, a flanged port connecting to the pumping system and a vacuum compatible electrical feed through as the data port.

4. A special feed through modified from a standard flange-mounted 25-pin connector, which is mounted directly to the fact of the vacuum chamber to save cost, weight and space and connected to the light deflecting system with a vacuum compatible cable.

5. A method of putting vacuum incompatible components, (mostly in the A/D converter), outside the vacuum chamber and connecting them with a shielded cable.

6. Methods of rotating the grating to accept light from VUV region and improving UV response by removing unnecessary windows, layers on top of optical components in the spectrometer.
